(19) United States
(12) Patent Application Publication
(10) Pub. No.: US 2023/0406443 A1
(43) Pub. Date: Dec. 21, 2023

(54) FRONT FORK

(71) Applicants: KYB Motorcycle Suspension Co.,Ltd., Gifu (JP); KYB Corporation, Tokyo (JP)

(72) Inventors: Hidetoshi SUGAWARA, Gifu (JP); Naoki ITO, Tokyo (JP); Takumi HAYASHIGUCHI, Tokyo (JP); Hirokatsu MAEDA, Gifu (JP)

(73) Assignees: KYB Motorcycle Suspension Co.,Ltd., Gifu (JP); KYB Corporation, Tokyo (JP)

(21) Appl. No.: 18/265,149

(22) PCT Filed: Dec. 10, 2021
(86) PCT No.: PCT/JP2021/045555

§ 371 Date: Jun. 2, 2023

(30) Foreign Application Priority Data
Feb. 15, 2021 (JP) 2021-021555

(51) Int. Cl. B62K 25/08; F16F 13/00

(52) U.S. Cl. CPC B62K 25/08; F16F 13/007; F16F 2222/12; F16F 2228/066; F16F 2230/30; F16F 2230/0052; F16F 2232/08; F16F 2234/02

(57) ABSTRACT

A front fork (1) of the present invention includes: a fork main body (2) having a vehicle body side tube (3) and an axle side tube (4); a cap (5) placed in the vehicle body side tube (3); a cylinder (6) provided inside the axle side tube (4); a rod (7) inserted into the cylinder (6) so as to be movable in an axial direction; an electric device (6) mounted inside the cylinder (6); an electric wire (9) connected to the electric device (8); a suspension spring (10) biasing the fork main body (2) in an extending direction, and an adjuster (11) capable of adjusting a support position of a spring seat (12). The electric wire (9) is drawn from the cap (5) at a position misaligned from an axial center line of the fork main body (2) to an outside of the fork main body (2). An operational portion (17) of the adjuster (11) is provided in the cap (5) at a position misaligned from the axial center line (A).

### TECHNICAL FIELD

The present invention relates to front forks.

### BACKGROUND ART

Telescopic front forks are a conventionally known example of front forks that support front steered wheels of straddle vehicles. A front fork of this type includes: a fork main body having a vehicle body side tube and an axle side tube that is movably inserted into this vehicle body side tube; and a damper that is mounted inside the fork main body and that expands/contracts in response to extending or shortening of the fork main body.

The damper includes: a cylinder; a piston that partitions an interior of the cylinder into an extension side chamber and a compression side chamber that are filled with a hydraulic liquid; and a piston rod that is inserted into the cylinder so as to be movable in an axial direction and is coupled to the piston. When the damper is mounted inside the fork main body, for example, the piston rod is coupled to a cap that covers as upper end of the vehicle body side tube, and the cylinder is fixed to a lower end of the axle side tube.

Some front forks, as described above, include as external controller that can adjust a damping force generated by the damper for the purse of improving ride comfort of the straddle vehicle. For example, for a front fork that can automatically adjust the damping force, electroviscous fluid or electromagnetic viscous fluid is used as a hydraulic liquid of the damper, and viscosity of the hydraulic liquid is varied by adjusting the amount of current supplied to a coil mounted inside the piston, so that the damping force can be varied. For another front fork that can automatically adjust the damping force, a solenoid valve is mounted inside the piston, and a damping force generated by a damper is adjusted by adjusting the amount of electricity supplied to the solenoid valve.

A front fork, as described above, that can automatically adjust the damping force includes, inside a damper, an electric device, such as a coil or a solenoid valve, used to adjust the damping force. It is thus necessary to supply power from an external power source or a controller to this electric device. Therefore, a conventional front fork, as disclosed in JP2014-190405A, includes, for example, a tubular piston rod and a cap with a through hole through which an electric wire is passed along its axial center. The electric wire connected to the electric device is passed through the interior of the piston rod, drawn from the interior of the fork main body to the outside via the through-hole in the cap and connected to an external power source or other device with the sealing of the electric wire ensured.

### CITATION LIST

### Patent Literature

Patent Literature 1: JP2014-190405A

### SUMMARY OF INVENTION

### Technical Problem

On the other hand, a typical front fork includes: an internal suspension spring to elastically support a vehicle body of a straddle vehicle; and an adjuster that can adjust a support position of a spring seat that supports an upper end of the suspension spring so that a vehicle height of the straddle vehicle can be set to that desired by a user.

The above adjuster is provided on the cap that covers the upper end of the vehicle body side tube of the front fork in consideration of user's operability. In the front fork equipped with the above electric device, a tubular operational portion of the adjuster used to vertically move the spring seat is screwed into the through-hole provided in the cap, and the electric wire is drawn from the interior of the fork main body to the outside after passed through the interior of the operational portion.

The front fork configured above employs a mechanism for, when the user rotates the operational portion along the circumference to move the operational portion in a vertical direction like a feed screw, vertically moving the spring seat linked to the operational portion. This mechanism achieves both electricity supply to the electric device in the fork main body and vehicle height adjustment.

If a front fork, as described above, is actually used, however, the operational portion in the adjuster is upsized in order to tightly seal the portion around the electric wire. As a result, a problem may arise in which the electric wire disturbs user's operation of the operational portion. In addition, a fixed arrangement of the electric wire and the operational portion extremely lowers the degree of freedom in design.

An object of the present invention is to provide a front fork that can downsize an operational portion in an adjuster even when an electric device is provided inside the adjuster and that also can improve the degree of freedom in design without causing an electric wire to disturb operation of the operational portion.

To accomplish the above purpose, a front fork in means for addressing a problem of the present invention includes: a telescopic fork main body having a vehicle body side tube and an axle side tube, the telescopic fork main body being extendable; a cap placed in a vehicle body side end of the vehicle body side tube; a cylinder provided inside the axle side tube; a rod inserted into the cylinder so as to be movable in an axial direction, the rod having one end coupled to the cap; an electric device mounted inside the cylinder; an electric wire connected to the electric device; a suspension spring mounted inside the fork main body, the suspension spring biasing the fork main body in an extending direction; and an adjuster capable of adjusting a support position of a spring seat by which the suspension spring is supported. The electric wire is drawn from the cap at a position misaligned from an axial center line of the fork main body to an outside of the fork main body. An operational portion of the adjuster is provided in the cap at a position that is misaligned from the axial center line of the fork main body and that is apart from the electric wire.

In the front fork configured above, the operational portion of the adjuster and the electric wire are disposed in the cap at positions misaligned from the axial center line of the fork main body. The operational portion is not disposed around the outer circumference of the electric wire. Therefore, the operational portion can be downsized independently of the diameter of the electric wire. In addition, both the electric wire and the operational portion can be relatively flexibly disposed in the cap because the electric wire does not interfere with user's operation of the operational portion.

### BRIEF DESCRIPTION OF DRAWINGS

FIG. 1 is a longitudinal sectional view of a front fork according cc an embodiment of the present invention.

FIG. 2 is an enlarged longitudinal sectional view of an upper-end portion of the front fork according to the embodiment of the present invention.

FIG. 3 is an enlarged plan view of the front fork according to the embodiment of the present invention as seen from an axial direction.

FIG. 4 is an enlarged sectional view of an adjuster portion in the front fork according to the embodiment of the present invention.

### DESCRIPTION OF EMBODIMENTS

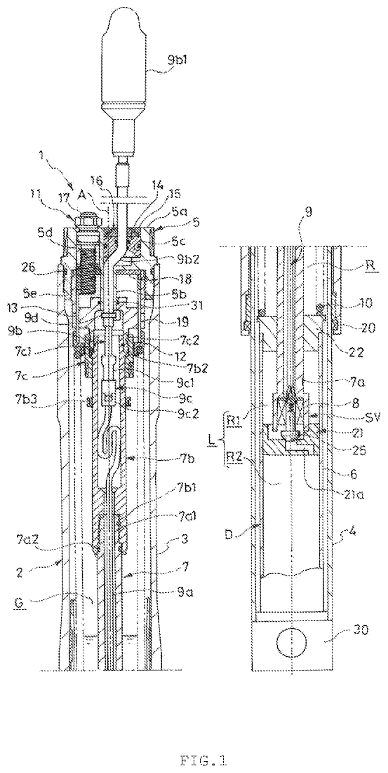

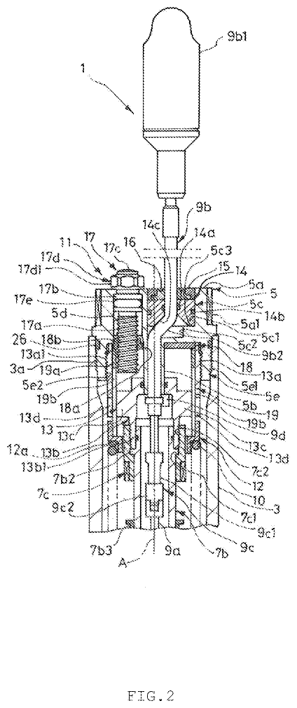

The present invention will be described below, based on some embodiments illustrated in the drawings. As illustrated in FIGS. 1 and 2, a front fork 1 according to an embodiment includes: an extendable telescopic fork main body 2 having a vehicle body side tube 3 and an axle side tube 4; a cap 5 placed in a vehicle body side end of the vehicle body side tube 3; a cylinder 6 provided inside the axle side tube 4; a piston rod 7, which is a rod that is inserted into the cylinder 6 so as to be movable in axial directions and that has an end coupled to the cap 5; a solenoid 8, which is an electric device mounted inside the cylinder 6; an electric wire 9 connected to the solenoid 8; a suspension spring 10 that is mounted inside the fork main body 2 and that biases the fork main body 2 in an extending direction; and an adjuster 11 that can adjust a supporting position of a spring seat 12 supporting the suspension spring 10. The vehicle body side tube 3 is coupled to a vehicle body (not illustrated) of a straddle vehicle, whereas the axle side tube 4 is coupled to the front wheels (not illustrated) of the straddle vehicle and is used in the straddle vehicle. Both of the vehicle body side tube 3 and the axle side tube 4 are displaced relative to each other along an axial center line A of the fork main body 2 due to vibrations during running of the straddle vehicle so that the front fork 1 extends or shortens.

Hereinafter, individual portions in the front fork 1 according to the embodiment will be described in detail. As illustrated in FIGS. 1 and 2, the front fork 1 includes the telescopic fork main body 2 having the vehicle body side tube 3 and the axle side tube 4 slidably inserted into the vehicle body side tube 3. When vibrations act on the fork main body 2, the axle side tube 4 moves into or from the vehicle body side tube 3 so that the fork main body 2 extends or shortens. Note that in the present embodiment, the fork main body 2 employs an inverted type in which the axle side tube 4 is inserted into the vehicle body side tube 3, although it may employ an upright type in which the vehicle body side tube 3 is inserted into the axle side tube 4.

Continuing the above, the cap 5 is placed in an upper end (in FIG. 2) of the vehicle body side tube 3, which corresponds to a vehicle body side end of the fork main body 2. The cap 5 thereby closes an opening of the upper end of the vehicle body side tube 3. Furthermore, a bracket 30 disposed on an axle side closes a lower end of the axle side tube 4 (in FIG. 1), which is a lower end of the fork main body 2. Moreover, an annular sealing member 20 that is placed in a lower end of the vehicle body side tube 3 and slidably in contact with an outer circumference of the axle side tube 4 closes a tubular gap formed between the vehicle body side tube 3 and the axle side tube 4.

In the above way, an interior of the fork main body 2 is formed as a sealed space, which accommodates a damper D. The damper D includes: the cylinder 6 mounted inside the axle side tube 4, a piston 21 slidably inserted into the cylinder 6; and the piston rod 7 having a lower end coupled to the piston 21 and an upper end that protrudes from the cylinder 6 to an outside thereof and that is coupled to the cap 5 via a rod adapter 13.

As described above, the piston rod 7 is coupled to the vehicle body side tube 3 via the cap 5, whereas the cylinder 6 is coupled to the axle side tube 4. As a result, the damper D is provided between the vehicle body side tube 3 and the axle side tube 4, so that the piston rod 7 moves in the axial directions relative to the cylinder 6, extending/shortening, in response to extending or shortening of the fork main body 2.

In the present embodiment, the piston rod. 7 includes: a cylindrical piston holding rod 7a coupled to the piston 21; a cylindrical connector accommodation rod 7b that is coupled to a lower end of the rod adapter 13 coupled to the cap 5 and screwed into an upper end of the piston holding rod. 7a; and a tubular coupling nut 7c by which the connector accommodation rod 7b is coupled to the rod adapter 13. The piston holding rod 7a includes: a threaded portion 7a1 provided on an outer circumference of the upper end (in FIG. 1) thereof; and a seal ring 7a2 placed in a portion of the outer circumference which is close to the threaded portion 7a1.

The connector accommodation rod 7b, which has a larger diameter than that of the piston holding rod 7a, includes a threaded portion 7b1 on an inner circumference of a lower end (in FIG. 1) thereof. By screwing the threaded portion 7a1 at the upper end of the piston holding rod 7a onto the threaded portion 7b1 on an inner circumference of a lower end (in FIG. 1) of the connector accommodation rod 7b, the piston holding rod 7a and the connector accommodation rod 7b are connected together in a screw fastening manner. A gap between the piston holding rod 7a and the connector accommodation rod 7b connected together in this manner is sealed by the seal ring 7a2 described above. Note that both the piston holding rod 7a and the connector accommodation rod 7b may be formed by a single integral component.

The connector accommodation rod 7b includes: a flange 7b2 on an outer periphery of an upper end (in FIG. 1) thereof; and a snap ring 7b3 provided on an outer periphery thereof at a position apart from the flange 7b2 toward a piston holding rod 7a side. The coupling nut 7c, which has an annular shape, is fitted into the outer periphery of the connector accommodation rod 7b and has an inner diameter on an upper side (in FIG. 1) thereof which increases at a midway. The coupling nut 7c includes: a step 7c1 facing a lower surface (in FIG. 1) of the flange 7b2 of the connector accommodation rod 7b; and a threaded portion 7c2 on an inner periphery on a rod adapter 13 side, which corresponds to an upper side (in FIG. 1) of the step 7c1. The coupling nut 7c is fitted into a rap between the flange 7b2 and the snap ring 7b3 on the outer periphery of the connector accommodation rod 7b and is suppressed from falling off from the connector accommodation rod 7b by the flange 7b2 and the snap ring 7b3.

The cylinder 6, which has a tubular shape, has an upper end (in FIG. 1) in which an annular rod guide 22 is placed. The piston holding rod 7a of the piston rod 7 is inserted into the rod guide 22 so as to be movable in the axial directions. The rod guide 22 slidably supports the piston rod 7 and Guides the piston rod 7 to move in the vertical directions (in FIG. 1).

A liquid chamber L filled with a liquid, such as a hydraulic oil, is formed inside the cylinder 6. The liquid chamber L is partitioned by the piston 21 into an extension side chamber R1 and a compression side chamber R2. The extension side chamber R1 described herein refers to, of the two chambers partitioned by the piston, one to be compressed by the piston 21 when the damper D expands. The compression side chamber R2 refers to, of the two chambers partitioned by the piston 21, one to be compressed by the piston 21 when the damper D contracts. The piston 21 is coupled to a lower end of the piston holding rod 7a of the piston rod 7.

As described above, the damper D in the front fork 1 according to the present embodiment employs a single rod type, in which the piston rod 7 extends from one side of the piston 21 to the outside of the cylinder 6. However, the damper D may also employ a double rod type, in which the piston rod extends from both the sides of the piston to the outside of the cylinder.

Furthermore, a space outside the cylinder 6, more specifically, a space between the damper D and the fork main body 2 is formed as a liquid storage chamber R. In the liquid storage chamber R, the liquid same as the cylinder 6 is stored, and a gas chamber G filled with a gas, such as air, is formed above a liquid level. In short, the fork main body 2 functions as an cuter shell of a tank that stores a liquid separately from the liquid in the cylinder 6.

Note that although not illustrated in the drawings, the liquid storage chamber R communicates with the compression side chamber R2 and is provided with a damping valve that gives resistance to a flow of the liquid from the compression side chamber R2 to the liquid storage chamber R and a check valve that permits only the flow of the liquid from the liquid storage chamber R to the compression side chamber R2.

The piston 21 provided with a damping passage 21a via which the extension side chamber R1 communicates with the compression side chamber R2 and a solenoid valve By that gives resistance to a flow of the liquid through the damping passage 21a. The solenoid valve SV includes: the solenoid 8 serving as an electric device; and a valve body 25 driven by the solenoid 8.

In the front fork 1 according to the present embodiment, although not illustrated in detail, the solenoid 8 includes, for example, a winding, a fixed iron core, a movable iron core inserted into the winding so as to be movable in the axial directions, and a spring that biases the movable iron core. By supplying electricity to the winding, the movable iron core is attracted toward the fixed iron core, so that the movable iron core has a thrust. In this case, the solenoid 8 transmits the thrust applied to the movable iron core to the valve body 25. By adjusting the current flowing through the winding, the thrust applied to the valve body 25 can be adjusted. Thus, the solenoid valve SV can adjust the resistance given to the flow of the liquid through the damping passage 21a in accordance with the amount of electricity supplied to the solenoid 8. The solenoid valve SV may be a variable relief valve in which a valve opening pressure is adjustable or may be a spool valve that can adjust an opening degree of the damping passage 21a. Note that the damping passage 21a may be provided with an orifice or a damping valve in series or in parallel with the solenoid valve SV.

The solenoid 8, which serves as the an electric device in the solenoid valve SV, is supplied with power from an external power source (not illustrated) through the electric wire 9 mounted inside the piston rod. 7. The electric wire 9 includes: an in-rod cable 9a that is connected to a winding (outside the drawings) of the solenoid 8 and inserted into the piston rod 7; and an outer cable 9b connected to the in-rod cable 9a via a connector 9c and held by the cap 5 to be drawn from the fork main body 2 to the outside.

The outer cable 9b includes a coupler 9b1 having one end connected to the in-rod cable 9a via the connector 9c and the other end connectable to a wire connected to an external power source (not illustrated). Thus, when the coupler 9b1 is connected to an electric wire (outside the drawings) on an external power source side, the electricity can be supplied to the winding of the solenoid 8 through the electric wire 9.

The connector 9c includes: a plug 9c1 provided therein with an internal pin (not illustrated) electrically connected to the outer cable 9b; and a receptacle 9c2 provided with an internal contact (not illustrated) electrically connected to the winding of the solenoid 8 via the in-rod cable 9a. When the plug 9c1 is mated with the receptacle 9c2, the connector 9c maintains a state in which the pin is inserted into the contact, so that the in-rod cable 9a is electrically connected to the outer cable 9b. When the plug 9c1 is unmated from the receptacle 9c2, the contact between the pin and the contact is broken off, so that the in-rod cable 9a is electrically disconnected from the cuter cable 9b. Alternatively, the outer cable 9b may be connected to the receptacle 9c2, whereas the in-rod cable 9a may be connected to the plug 9c1.

The maximum width of the connector 9c is smaller than the inner diameter of the connector accommodation rod 7b of the piston rod 7. The connector 9c is thus accommodatable in the connector accommodation rod 7b and accessible to the interior of the connector accommodation rod 7b from the top of the connector accommodation rod 7b. Furthermore, the in-rod cable 9a has an extra length so that the connector 9c can be removed upward from the connector accommodation rod 7b. When being disposed inside the connector accommodation rod 7b, the connector 9c slackens.

When the fork main body 2 extends to expand the damper D, the piston 21 moves upward (in FIG. 1) away from the cylinder 6. Then, the extension side chamber R1 is compressed, whereas the compression side chamber R2 expands. As a result, the liquid in the compressed extension side chamber R1 flows into the expanding compression side chamber R2 through the damping passage 21a of the piston 21. Since the solenoid valve SV gives resistance to the flow of the liquid, the pressure in the extension side chamber R1 increases, causing the damper D to generate a damping force that hinders the fork main body 2 from extending. Upon the extending of the damper D, the piston rod 7 is moved from the interior of the cylinder 6, so that the amount of the liquid in the cylinder 6 becomes insufficient in accordance with this movement of the piston rod 7. Accordingly, an amount of liquid which is large enough to compensate for the insufficiency is supplied into the cylinder 6 from the liquid storage chamber R through the above check valve.

Conversely, when the fork main body 2 shortens to compress the damper D, the piston 21 moves downward (in FIG. 1) toward the cylinder 6. Then, the compression side chamber R2 is compressed, whereas the extension side chamber R1 expands. As a result, the liquid in the compressed compression side chamber R2 moves into the enlarged extension side chamber R1 through the damping passage 21a of the piston 21. Furthermore, upon the contraction of the damper D, the piston rod 7 moves into the cylinder 6, so that the amount of the liquid in the cylinder 6 becomes excessive in accordance with this movement of the piston rod 7. Accordingly, an excessive amount of the liquid is discharged from the compression side chamber R2 to the liquid storage chamber R through the damping valve. The solenoid valve SV gives resistance to the flow of the liquid to the extension side chamber R1, whereas the damping valve gives resistance to the flow of the liquid to the liquid storage chamber R. As a result, the pressure in the compression side chamber R2 increases, causing the damper D to generate the damping force that hinders the fork main body 2 from being compressed.

In this case, it is possible to adjust the resistance given by the solenoid valve SV to the flow of the liquid by adjusting a current supplied to the solenoid 8 in the solenoid valve SV. In the front fork 1 according to the present embodiment, the damping force generated by the damper D can be adjusted upon both the expanding and compressing of the damper D.

Continuing to the above, the cap 5 includes: a disc-shaped lid 5a that covers an upper end opening (in FIG. 2) of the vehicle body side tube 3; a cylindrical portion 5b that protrudes into the fork main body from a fork side end, which is a lower side (in FIG. 2) of the lid 5a and has a center aligned with the axial center line A; an electric wire hole 5c that is formed into the cylindrical portion 5b from an opposite fork main body side end of the lid 5a, which is an upper side (in FIG. 2) thereof and has a center misaligned from the axial center line A; an adjuster hole 5d that is provided in the lid 5a at a position misaligned from the axial center line A and apart from the electric wire hole 5c and formed across the lid 5a in a vertical direction, or the axial direction; and an annular socket 5e erected from an outer circumference of the fork side end of the 5a toward the fork main body.

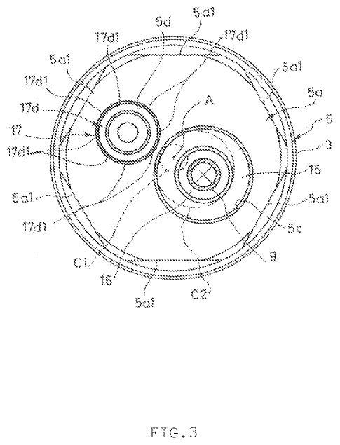

The cap 5 is securely screwed into the vehicle body side tube 3 by screwing a socket 5e having a threaded portion 5e1 on an outer circumference thereof into a threaded portion 3a provided on an inner circumference of the upper end of the vehicle body side tube 3. When the cap 5 is screwed into the inner circumference of the upper end of the vehicle body side tube 3, the lid 5a of the cap 5 covers an upper end opening of the vehicle body side tube 3. A seal ring 26 is placed in an outer circumference of the socket 5e on a lid 5a side from a threaded portion 5e1. The seal ring 26 seals the gap between the cap 5 and the vehicle body side tube 3. As illustrated in FIG. 3, six notches Sal are provided at respective positions on an outer circumference of the lid 5a with equal intervals therebetween in a circumferential direction so that the cap 5 can be gripped by a tool (outside the drawings) when the cap 5 is being screwed into the vehicle body side tube 3. The threaded portion 5e2 is also provided on an inner circumference of the socket 5e.

The cylindrical portion 5b is a cylinder having a center aligned with the center of the lid 5a which coincides with the axial center line A of the fork main body 2 and is provided so as to protrude toward the fork main body from a fork main body side end of the lid 5a, which is the lower side (in FIG. 2) thereof.

As illustrated in FIGS. 2 and 3, the electric wire hole 5c is formed across the lid 5a in the vertical direction (in FIG. 2), or in the axial direction, and leads to the interior of the cylindrical portion 5b. Specifically, the electric wire hole 5c of the lid 5a is formed of a large-diameter hole portion 5c1 having a circular cross section opened from an end on an opposite fork main body side and a small-diameter hole portion 5c2 that has a circular cross section opened from a bottom portion of the large-diameter hole portion 5c1 so as to lead to the interior of the cylindrical portion 5b and that has a smaller diameter than that of the large-diameter hole portion 5c1.

As illustrated in FIGS. 2 and 3, the large-diameter hole portion 5c1 is formed to have a circular cross section, and is formed in the lid 5a along the axial direction so that the center of the opening thereof is shifted or misaligned from the axial center line A on an opposite fork side end of the lid 5a, which is an upper side (in FIG. 2) thereof. The small-diameter hole portion 5c2 is a hole having a circular cross section smaller in diameter than the large-diameter hole portion 5c1 and is formed along the axial direction of the lid 5a so as to lead to the large-diameter hole portion 5c1 of the lid 5a. The center of the small-diameter hole portion 5c2 is shifted or misaligned from the axial center line A of the lid 5a. In the front fork 1 according to the present embodiment, when the cap 5 is seen in the axial direction, the electric wire hole 5c is formed in the lid 5a so that a circle (a circle indicated by a one-dot chain line in FIG. 3) C2 which coincides with the inner circumferential surface of the small-diameter hole portion 5c2 and a circle (a circle indicated by a broken line in FIG. 3) C1 coinciding with the inner circumferential surface of the cylindrical portion 5b are contained in a range surrounded by a circle coinciding with the inner circumferential surface of the large-diameter hole portion 5c1. The electric wire hole 5c has only to be provided so that the center of the opening in the lid 5a on the opposite fork main body side end is disposed at a position misaligned from the axial center line A. Therefore, the electric wire hole 5c may be provided so as to lead to the interior of the cylindrical portion 5b in a direction inclined with respect to the axial center line A.

Unless the center of the opening of the electric wire hole 5c in the lid 5a on the opposite fork main body side end is aligned with the axial center line A, the electric wire hole 5c may be formed in the lid 5a so that the axial center line A is disposed inside the opening. Alternatively, the electric wire hole 5c may be formed in the lid 5a in accordance with a positional relationship in which the axial center line A is disposed outside the opening. Although the small-diameter hole portion 5c2 does not necessarily have to be formed; however, providing the small-diameter hole portion 5c2 can provide a step 5c3 at a midway inside the electric wire hole 5c so as to face the opposite fork main body side. Since the small-diameter hole portion 5c2 has only to be formed so that the large-diameter hole portion 5c1 leads to the interior of the cylindrical portion 5b, the small-diameter hole portion 5c2 may be formed so that the small-diameter hole portion 5c2 at least overlaps the large-diameter hole portion 5c1 as the cap 5 is seen in the axial direction. Furthermore, each of the large-diameter hole portion 5c1 and the small-diameter hole portion 5c2 may have a cross section that does not have a circular shape. The geometric center of the cross-sectional shape of the opening of the large-diameter hole portion 5c1 has only to be at a position misaligned from the axial center line A.

An annular guide 14 is fitted into the large-diameter hole portion 5c1 of the electric wire hole 5c. The guide 14 includes: an inner circumferential seal ring 14a mounted inside an annular groove provided in the circumferential direction on an inner circumference thereof; an outer circumferential seal ring 14b mounted inside an annular groove provided in the circumferential direction on an outer circumference thereof; and a tapered portion 14c on the inner circumference on a fork main body side and a lower side (in FIG. 2) of the inner circumferential seal ring 14a, whose diameter increases toward the fork main body.

Since the guide 14 is fitted into the electric wire hole 5c whose center is misaligned from the axial center line A, the guide 14 is also disposed in the lid 5a with its center misaligned from the axial center line A.

An annular seal holder 15 is press-fitted into the large-diameter hole portion 5c1 and on an upper side (in FIG. 2), which is an opposite fork main body side of the guide 14, as described above. The inner diameter of the seal holder 15 on a guide side increases so that the outer circumference of the annular packing 16 inserted on the inner circumferential side can be gripped together with the guide 14.

The outer cable Sb of the electric wire 9 is inserted into and passed along the inner circumferential sides of the guide 14 fixed in the electric wire hole 5c of the cap 5, as described above, and packing 16. The outer circumference of the electric wire 9 is sealed by the inner circumferential seal ring 14a on the inner circumference of the guide 14 and the packing 16 held by the seal holder 15. A gap between the Guide 14 and the cap 5 is sealed by the outer circumferential seal ring 14b on the outer circumference of the guide 14.

The guide 14 not only holds the electric wire 9, holds the inner circumferential seal ring 14a and the outer circumferential seal ring 14b, and positions the electric wire 9 relative to the cap 5 but also plays a role of bearing a load in the axial direction upon press-fitting of the seal holder 15. In short, the guide 14 exhibits many functions.

The outer cable 9b extends downward (in FIG. 2) through both the small-diameter hole portion 5c2 and the cylindrical portion 5b. The outer cable 9b of the electric wire 9 goes out from an upper end of the cylindrical portion 5b whose center is aligned with the axial center line A and is drawn outward through the electric wire hole whose center is misaligned from the axial center line A. In short, the electric wire 9 is drawn from the cap 5 at a position misaligned from the axial center line A of the fork main body 2 to an outside of the cap 5.

The outer cable 9b of the electric wire 9 is inserted into the guide 14 while bent at a position where the electric wire 9 Goes out from the upper end of the cylindrical portion 5b. Thus, even if a force acts on the outer cable 9b in a direction in which the outer cable 9b is drawn to the outside of the fork main body, the electric wire 9 is not easily drawn to the outside because a portion (bent portion) 9b2 acts as a resistance.

Furthermore, an annular stopper 9d that faces a fork main body side end of the cylindrical portion 5b, which is a lower side (in. FIG. 2) thereof is provided around the outer circumference of the outer cable 9b and close to the lower side of the cylindrical portion 5b. Thus, even when a large force acts on the outer cable 9b in the direction in which the outer cable 9b is drawn from the fork main body, the stopper 9d abuts on the lower side (in FIG. 2) of the cylindrical portion 5b, suppressing the outer cable 9b from being further displaced in a drawing direction. As a result, the electric wire 9 is prevented from being drawn from the fork main body. In this case, the stopper 9d may be any member that cannot pass through the cylindrical portion 5b when placed in the outer circumference of the outer cable 9b. The stopper 9d may be a binding band or a similar binding member because the outer cable 9b can be easily attached to the cap 5 if the stopper 9d can be attached to the outer cable 9b after the outer cable 9b has been attached to the cap 5.

The guide 14 is provided with the tapered portion 14c by which the diameter of the inner circumference of the guide 14 increases toward the fork main body side. The outer cable 9b is thus bent along the surface of the tapered portion 14c. As a result, the guide 14 suppresses an excessive load from being applied in a drawing direction to the bent portion 9b2 of the outer cable 9b. In addition, when a force is applied to the electric wire 9, the bent portion 9b2 can be supported by the circumferential surface of the tapered portion 14c and is protected accordingly.

The adjuster hole 5d is provided in the lid 5a at a position misaligned from the axial center line A and apart from the electric wire hole 5c and is formed across the lid 5a in the vertical direction, or the axial direction. The adjuster hole 5d is a hole having a circular cross section. An inner diameter of the adjuster hole 5d on an opposite fork main body side thereof, which is an upper end (in FIG. 2), is smaller than that of a lower end (in FIG. 2).

The rod adapter 13 by which the cap 5 is coupled to the piston rod 7 includes: the outer tube 13a screwed into an inner circumference of the socket 5e of the cap 5; an inner tube 13b coupled to an upper end (in FIG. 2) of the piston rod 7; and a pair of connection portions 13c, 13c by which the outer tube 13a is coupled to the inner tube 13b and which is provided so as to have a phase difference of 180 degrees in the circumferential direction.

The outer tube 13a includes a threaded portion 13a1 on an outer circumference at an upper end (in FIG. 2) thereof which is screwed into a threaded portion 5e2 on an inner circumference of the socket 5e. In addition, the inner tube 13b includes a threaded portion 13b1 to the outer circumference at the lower end (in FIG. 2) to which a coupling nut 7c of the piston rod 7 is screwed. The upper end (in FIG. 2) of the connector accommodation rod 7b in the piston rod 7 is inserted into the lower end of the inner tube 13b. The coupling nut 7c fitted into the outer circumference of the connector accommodation rod 7b is screwed into the threaded portion 13b1 of the inner tube 13b. Then, when the coupling nut 7c firmly screwed into the inner tube 13b, the flange 7b2 provided on the outer circumference of the connector accommodation rod 7b is strongly pinched between a step 7c1 on the inner circumference of the coupling nut 7c and the lower end (in FIG. 2) of the inner tube 13b, so that the piston rod 7 is coupled to the rod adapter 13.

The outer tube 13a and the inner tube 13b are not coupled over the entire circumferences but are coupled by the connection portions 13c, 13c provided at intervals in the circumferential direction. Two arc-shaped through-holes 13d, 13d are thus formed between the outer tube 13a and the inner tube 13b.

When the threaded portion 13a1 and the threaded portion 5e2 are screwed in together while the cuter tube 13a of the rod adapter 13 configured as described above is inserted into the socket 5e of the cap 5, the rod adapter 13 is coupled to the cap 5, and an end of the cylindrical portion 5b of the cap 5 is inserted into and fitted into the inner circumference of the inner tube 13b on the upper end side (in FIG. 2).

As illustrated in FIG. 1, a gap between the cylindrical portion 5b and the inner tube 13b is sealed by a seal ring 31 placed in an inner circumference of the inner tube 13b of the rod adapter 13. Likewise, a gap between the piston holding rod 7a and the connector accommodation rod 7b is sealed by the seal ring 7a2. The outer circumference of the electric wire 9 is sealed by the packing 16 and the inner circumferential seal ring 14a, whereas the gap between the guide 14 and the cap 5 is sealed by the outer circumferential seal ring 14b. Therefore, spaces formed in the piston rod 7, the cylindrical portion 5b, and the electric wire hole 5c of the cap 5 are isolated from the outside. This can block entry of liquid from the interior of the liquid storage chamber R into these spaces and entry of water, dust, and other foreign matter from the outside of the front fork, thereby protecting the electric wire 9 mounted inside the spaces.

Continuing to the above, the adjuster 11 includes: an operational portion 17 inserted into the adjuster hole of the cap 5; a plate 18 that moves in the vertical directions in response to operation of the operational portion 17; and a movable element 19 that is stacked on the plate 18 and fitted into the spring seat 12. The adjuster 11 can displace the movable element 19 relative to the cap 5 along the axial center line A of the fork main body 2 together with the spring seat 12, in response to the operation of the operational portion 17.

The spring seat 12 is movable relative to the cap 5 in the vertical directions (in FIG. 1) and supports an upper end (in FIG. 1) of a suspension spring 10 formed of a coil spring disposed between the spring seat 12 and the rod guide 22. The suspension spring 10 exerts a resilient force so as to separate the vehicle body side tube 3 and the axle side tube 4 from each other, thereby biasing the fork main body 2 in the extending direction. Therefore, when disposed between the front wheel and the vehicle body of the straddle vehicle described (outside the drawings), the front fork 1 elastically supports the vehicle body.

The spring seat 12 is movable relative to the cap 5 in directions along the axial center line A of the fork main body 2, which are the vertical directions (in FIG. 1). The support position of the upper end (in FIG. 1) of the suspension spring 10 is changed depending on the operation of the adjuster 11. Therefore, in the front fork 1, the spring seat 12 can be displaced in the vertical directions by the operation of the adjuster 11 so that the support position of the upper end on the suspension spring 10 can be changed and a vehicle height of the straddle vehicle can be adjusted.

Hereinafter, the adjuster 11 will be described in detail. As illustrated in FIG. 2, the operational portion 17 includes: a screw shaft 17a; a flange 17b provided at an upper end (in FIG. 2) of the screw shaft 17a; a shaft portion 17c protruding from an axial center of the flange 17b; and an annular operational knob 17d attached to an outer circumference of the shaft portion 17c. The operational portion 17 is mounted inside the adjuster hole 5d of the lid 5a so as to be rotatable in circumferential directions except for the shaft portion 17c and the operational knob 17d.

A seal ring 17e is placed in the outer circumference of the flange 17b and seals a gap between the operational portion 17 and the lid 5a, suppressing leakage of the liquid from the interior of the liquid storage chamber R to the outside of the fork main body 2.

The screw shaft 17a, the flange 17b, and the shaft portion 17c are all formed of a single component. An outer circumferential shape of the shaft portion 17c and an inner circumferential shape of the operational knob 17d are any shapes other than a circle, such as a width-across shape or a hexagonal shape and coincide with each other. Thus, when the operational knob 17d is fitted into the outer circumference of the shaft portion 17c, the rotation of the shaft portion 17c relative to the operational knob 17d in the circumferential directions is inhibited.

As illustrated in FIG. 3, six notches 17d1 are provided at respective positions around the outer circumference of the operational knob 17d with equal intervals therebetween so as to be easily gripped by a wrench. The operational knob 17d is larger in outer shape than the adjuster hole 5d and cannot enter the adjuster hole 5d. The operational knob 17d is suppressed from falling off from the shaft portion 17c by a C pin (not illustrated), which is placed in the outer circumference of the shaft portion 17c. The flange 17b mounted inside the adjuster hole 5d has an outer diameter larger than an inner diameter of the adjuster hole 5d on the opposite fork main body side which is the minimum diameter thereof and pinches the lid 5a in a thickness direction together with the operational knob 17d. Thus, both the operational knob 17d and the flange 17b suppress the operational portion 17 from moving in the vertical directions (in FIG. 2), or the axial direction. As described above, when the operational knob 17d is operated by being rotated, the entire operational portion 17 rotates in the circumferential directions.

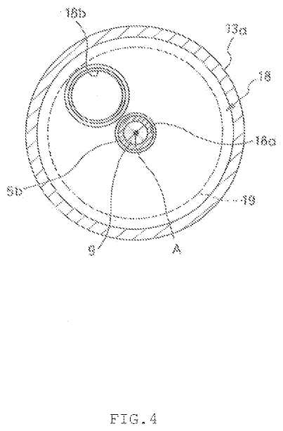

The disk-shaped plate 18 is screwed into the screw shaft 17a of the operational portion 17. As illustrated in FIG. 4, the plate 18 includes, at its center: a through-hole 18a through which the cylindrical portion 5b of the cap 5 is passed; and a screw hole 18b screwed into the outer circumference of the screw shaft 17a. The plate 18 is fitted into the inner circumference of the outer tube 13a of the rod adapter 13 so as to be movable in the axial directions.

The plate 18 is suppressed from rotating by the outer tube 13a of the rod adapter 13. When the operational portion 17 is operated by being operated, the plate 18 is displaced inside the outer tube 13a of the rod adapter 13 in the directions along the axial center line A of the fork main body 2, or the vertical directions (in FIG. 2). Note that although the plate 18 is circular in outer shape, it may have any shape other than a circular shape as long as the plate 18 is prevented from rotating by the rod adapter 13.

The movable element 19 includes a cylindrical portion 19a that abuts on the plate 18; and a pair of protruding pieces 19b, 19b protruding from a fork main body side end of the cylindrical portion 19a, which is a lower end (in FIG. 2) thereof. The protruding pieces 19b, 19b have an arcuate cross section, extend downward (in FIG. 2) from the cylindrical portion 19a in the axial direction, pass between the connection portions 13c, 13c of the rod adapter 13, and protrude outward from the rod adapter 13 through the through-holes 13d, 13d.

The spring seat 12, which has an annular shape, has an upper diameter larger than a lower diameter thereof and is provided with a step 12a at a midway in the axial direction. The spring seat 12 supports an upper end (in FIG. 2) of the suspension spring 10 with the step 12a and is coupled to the movable element 19 by fitting the inner circumference on the large-diameter side to the outer surfaces of the ends of the protruding pieces 19b, 19b of the movable element 19.

In the adjuster 11 configured above, when the plate 18 moves upward or downward in response to the rotational operation of the operational portion 17, the movable element 19 and the spring seat 12 coupled to the movable element 19 are also displaced in the vertical direction together with the plate 18. Thus, performing the rotation operation of the operational portion 17 can adjust the support position of the spring seat 12 supporting the suspension spring 10 in the vertical direction (in FIG. 1), so that the vehicle height of the straddle vehicle to which the front fork 1 is applied can be adjusted. To suppress the plate 18 from interfering with the lid 5a and the rod adapter 13 when the plate 18 moves upward or downward within the adjustment range of the vehicle height adjustment described above, a sufficient gap that allows the plate 18 to move is provided between the lid 5a of the cap 5 and the inner tube 13b of the rod adapter 13.

When the front fork 1 configured above is subjected to a maintenance process, the cap 5 is removed from the vehicle body side tube 3. The rod adapter 13 is then removed from the piston rod 7. Subsequently, the connector 9c is drawn from the connector accommodation rod 7b. The plug 9c1 of the connector 9c is removed from the receptacle 9c2. The in-rod cable 9a is separated from the outer cable 9b. The outer cable 9b is completely removed from the fork main body 2 together with the cap 5 and the rod adapter 13. In this way, both the cap 5 and the rod adapter 13 can be completely removed from the vehicle body side tube 3 without receiving interference from the electric wire 9. When both the cap 5 and the rod adapter 13 are removed from the vehicle body side tube 3, the disassembly process has been completed. The upper end opening portion of the vehicle body side tube 3 is completely exposed so that it is possible to start the maintenance process, such as that of replacing the suspension spring 10 and the seal in the fork main body 2, or replacing or supplying the hydraulic oil in the damper D and the liquid storage chamber R.

When an assembly in which the cap 5, the rod adapter 13, and the outer cable 9b are integrated with one another is attached to the fork main body 2 after the completion of the maintenance process, the plug 9c1 is connected to the receptacle 9c2, and then the in-rod cable 9a is connected to the outer cable 9b. Subsequently, after the rod adapter 13 has been coupled to the piston rod 7 by using the coupling nut 7d, the vehicle body side tube 3 is rotated relative to the cap 5 to securely screw the vehicle body side tube 3 into the threaded portion 5e1 on the outer periphery of the cap 5. In the front fork 1 according to the present embodiment, as described above, both the cap 5 and the rod adapter 13 can be attached to or detached from the fork main body 2. The cap 5 thereby can be completely separated from the fork main body 2. There is no possibility of twisting the electric wire 9 upon attaching or detaching the cap 5. It is therefore possible to suppress the electric wire 9 from being disconnected or fatigued.

A front fork 1 according to the present embodiment includes: a telescopic fork main body 2 having a vehicle body side tube 3 and an axle side tube 4, the telescopic fork main body 2 being extendable; a cap 5 placed in a vehicle body side end of the vehicle body side tube 3; a cylinder 6 provided inside the axle side tube 4; a piston rod (rod) 7 inserted into the cylinder 6 so as to be movable in an axial direction, the piston rod (rod) 7 having one end coupled to the cap 5; a solenoid (electric device) 8 mounted inside the cylinder 6; an electric wire 9 connected to the solenoid (electric device) 8; a suspension spring 10 mounted inside the fork main body 2, the suspension spring 10 biasing the fork main body 2 in an extending direction; and an adjuster 11 capable of adjusting a support position of a spring seat 12 by which the suspension spring 10 is supported. The electric wire 9 is drawn from the cap 5 at a position misaligned from an axial center line A of the fork main body 2 to an outside of the fork main body 2. An operational portion 17 of the adjuster 11 is provided in the cap 5 at a position that is misaligned from the axial center line A of the fork main body 2 and that is apart from the electric wire 9.

In the front fork 1 configured above, the operational portion 17 of the adjuster 11 and the electric wire 9 are disposed in the cap 5 at respective positions misaligned from the axial center line A of the fork main body 2. The operational portion 17 is not disposed around the outer circumference of the electric wire 9. Therefore, the operational portion 17 can be downsized independently of the diameter of the electric wire 9. In addition, both the electric wire 9 and the operational portion 17 can be relative flexibly disposed in the cap 5 because the electric wire 9 is less likely to interfere with user's operation of the operational portion 17.

According to the front fork 1 of the present embodiment, as described above, even when the solenoid (electric device) 8 is provided inside, the operational portion 17 or the adjuster 11 can be downsized. In addition, the electric wire 9 does not disturb operation of the operational portion 17. Consequently, it is possible to improve the degree of freedom in design.

In the front fork 1 of the present embodiment, the piston rod (rod) 7 has a tubular shape. In addition, the electric wire 9 is drawn from the cylinder 6 to the outside through the interior of the piston rod (rod) 7. According to the front fork 1 configured above, the electric wire 9 does not disturb a displacement of the piston rod (rod) 7 relative to the cylinder 6. The fork main body 2 thereby can smoothly extend or shorten.

In the front fork 1 of the present embodiment, the cap 5 includes a lid 5a having a disc shape, a cylindrical portion 5b that protrudes from a fork side end of the lid toward an interior of the fork main body and that has a center aligned with the axial center line A, and an electric wire hole 5c leading from an opposite fork main body side end of the lid 5a to the interior of the cylindrical portion 5b, a center of an opening at an opposite fork side end of the 5a being misaligned from the axial center line A. The cap 5 is provided with a guide 14 having an annular shape, the guide 14 being mounted inside the electric wire hole 5c, the guide 14 having an inner circumference along which the electric wire 9 is passed. The electric wire 9 is inserted into and passed in a bent shape through interiors of the cylindrical portion 5b and the guide 14. According to the front fork 1 configured above, the electric wire 9 is positioned, relative to the cap 5 by using the guide 14, in the electric wire hole 5c having an opening larger than that of the electric wire 9. The electric wire 9 thereby can be inserted into the electric wire hole 5c. In addition, the electric wire 9 is bent by both the guide 14 and the cylindrical portion 5b. Therefore, even if a force of drawing the electric wire 9 from the cap 5 is applied to the electric wire 9, the bent portion 9b2 of the electric wire 9 exerts friction, thereby suppressing the electric wire 9 from being drawn from the cap 5. With the guide 14, the electric wire 9 can be positioned on the opposite fork main body side end of the cap 5 at a position misaligned from the axial center line A, and the electric wire 9 can be bent, Moreover, the center of the cylindrical portion 5b is aligned with the axial center line A. Thus, when the electric wire 9 is drawn to the outside of the cylinder 6 through the interior of the piston rod (rod) 7, the electric wire 9 is easily inserted into the cylindrical portion 5b. Consequently, it is possible to easily perform the process of assembling the front fork 1.

As long as the opening of the electric wire hole 5c formed on the opposite fork main body side of the cap 5 is misaligned from the axial center line A, the guide 14 does not necessarily have to be provided. In the front fork 1 of the present embodiment, the electric wire hole 5c is continuously formed across the cylindrical portion 5b in the axial direction. More specifically, as the cap 5 is seen in the axial direction, the electric wire hole 5c is formed in the lid 5a so that a circle that coincides with the inner circumferential surface of the small-diameter hole portion 5c2 and a circle that coincides with the inner circumferential surface of the cylindrical portion 5b are positioned inside a range surrounded by a circle that coincides with the inner circumferential surface of the large-diameter hole portion 5c1. When the electric wire hole 5c is continuously formed across the cylindrical portion 5b in the axial direction as described above, the electric wire 9 does not have to be bent when inserted into the electric wire hole 5c of the cap 5 and passed through the cylindrical portion 5b. Consequently, it is possible to easily perform the process of attaching the electric wire 9 to the cap 5.

The front fork 1 of the present embodiment further includes: an outer circumferential seal ring 14b that seals a gap between an outer circumference of the guide 14 and the cap 5; and annular packing 16 that is stacked on the guide 14 and seals a gap between the guide 14 and the electric wire 9. As described above, even when the electric wire 9 is drawn to the outside through the electric wire hole 5c of the cap 5, the gap between the electric wire 9 and the cap 5 is sealed. Water, dust, and other foreign matter thereby can be prevented from entering the fork main body 2. An annular groove may be provided on the inner wall of the electric wire hole 5c of the cap 5, and the outer circumferential seal ring 14b may be placed in the annular groove and held on the cap 5.

The front fork 1 of the present embodiment further includes an inner circumferential seal ring 14a that seals the inner circumference of the guide 14 and an outer circumference of the electric wire 9. According to the front fork 1 configured above, the outer circumference of the electric wire 9 is sealed by the packing 16 as well as by the inner circumferential seal ring 14a. The interior of the fork main body 2 thereby can be tightly enclosed. Even if a straddle vehicle equipped with the front fork 1 is cleaned by a high-pressure cleaning machine, the front fork 1 can effectively block entry of water into the fork main body 2.

In the front fork 1 of the present embodiment, the guide 14 has a tapered portion 14c on the inner circumference on a fork main body side thereof, the tapered portion having a diameter increasing toward the fork main body side. According to the front fork 1 configured above, the electric wire 9 is bent along the surface of the tapered portion 14c. Thus, an excessive load is hardly applied to the bent portion 9b2 of the electric wire 9. Even when a force is applied to the electric wire 9 in the drawing direction, the bent portion 9b2 can be supported by the circumferential surface of the tapered portion 14c, so that the electric wire 9 can be protected. In addition, in the front fork 1 of the present embodiment, the guide 14 inevitably has a long axial length (length in the vertical direction in FIG. 2) due to the relationship in which both the inner circumferential seal ring 14a and the outer circumferential seal ring 14b are provided. When the tapered portion 14c is not provided on the inner circumference, the angle that the bent portion 9b2 of the electric wire 9 forms with the direction of the axial center line A becomes large. In other words, even if the axial length of the guide 14 increases because the guide 14 holds both the inner circumferential seal ring 14a and the outer circumferential seal ring 14b, the angle of the bent portion 9b2 of the electric wire 9 can be made obtuse by providing the tapered portion 14c on the inner circumference of the guide 14. Consequently, it is possible to lighten a load on the bent portion 9b2. In this case, the tapered portion 14c of the guide 14 does not necessarily have to be provided. When the angle of the bent portion 9b2 needs to be made obtuse, the diameter of the inner circumference of the guide 14 on the fork main body side may be made large instead of providing the tapered portion 14c, and the support position of the electric wire 9 in the guide 14 may be made as high as possible in FIG. 2.

The front fork 1 of the present embodiment further includes a stopper 9d on the outer circumference of the electric wire 9, the stopper 9d facing a fork main body side end of the cylindrical portion 5b. According to the front fork 1 configured above, even if a large force acts on the electric wire 9 in the direction of drawing the electric wire 9 from the fork main body 2, the stopper 9d can abut on the cylindrical portion 5b, thereby suppressing the electric wire 9 from being further displaced in the drawing direction. Consequently, it is possible to suppress the electric wire 9 from being drawn from the fork main body 2.

As described above, the adjuster 11 in the front fork 1 of the present embodiment includes the operational portion 17, a plate 18 screwed into a screw shaft 17a of the operational portion 17, and a movable element 19 that abuts on the plate 18 and is fitted into the spring seat 12. With this configuration of the adjuster 11, the operational portion 17 can be easily disposed in the cap 5 at a position which is misaligned from the axial center line A of the fork main body 2 and at which the operational portion 17 is not interfered with by the electric wire 9. In this case, the adjuster 11 may employ any other configuration that enables the adjuster 11 to change the supporting position of the spring seat 12, which is provided with the operational portion and supports the upper end of the suspension spring 10. For example, when the operational portion 17 is screwed into the cap 5 and is moved upward or downward in response to a rotational operation, the adjuster 11 may employ a structure in which the plate 18 is not provided and the lower end of the operational portion 17 is directly brought into contact with the upper end of the movable element 19. Alternatively, the adjuster 11 may employ a structure in which the plate 18 is not provided and a tubular locknut is screwed on the outer circumference of the screw shaft 17a of the operational portion 17 and the lower end of the nut is brought into contact with the movable element 19. As described above, The design of the adjuster 11 can be modified as appropriate as long as the adjuster 11 employs a structure in which the electric wire 9 is not interfered with.

In the front fork 1 of the present embodiment, the piston rod 7 includes: a cylindrical piston holding rod 7a coupled to the piston 21; and a tubular connector accommodation rod 7b coupled to the lower end of the cap 5. The connector accommodation rod 7b has a diameter larger than that of the piston holding rod 7a. In the front fork 1 of the present embodiment, the connector 9c bulkier than the electric wire 9 is mounted inside the connector accommodation rod 7b having a large-diameter, and only the piston holding rod 7a having a small-diameter is inserted into the cylinder 6 of the damper D. In the front fork 1 configured above, the bulky connector 9c is mounted inside the connector accommodation rod 7b outside the cylinder 6 and only the piston holding rod 7a having a small outer diameter is inserted into the cylinder 6. Thus, a pressure receiving area of the piston 21 can be secured without increasing the diameter of the cylinder 6. Consequently, it is possible to sufficiently exert an extension side damping force and, nevertheless, to avoid upsizing of the front fork 1.

In the front fork 1 of the present embodiment, the electric wire 9 has a configuration in which an in-rod cable 9a is connected to an outer cable 9b via a connector 9c. With this configuration, the front fork 1 can easily be maintained. However, the electric wire 9 does not have to be separated at a midway, in other words, may have a configuration in which one end thereof is connected to the solenoid (electric device) 8 and the other end thereof is drawn from the electric wire hole 5c of the cap 5.

In the front fork 1 of the present embodiment, the solenoid 8 is used as the electric device; however, the electric device is not limited to the solenoid 8. Alternatively, the electric device may be a coil in a case where the damper D is a damper using electroviscous fluid or electromagnetic viscous fluid and the coil is used to change viscosity. Furthermore, the electric device may be a sensor or other similar device that detects the pressure in the damper D or detects the extending or shortening displacement of the fork main body 2 in addition to the electric device used for adjusting The damping force of The damper D in the front fork 1 or may include: a device that adjusts the damping force; and a plurality of sensing devices. In short, the present invention may be applicable to the front fork 1 in which the electric device is mounted inside the cylinder 6. In this case, a state where at least a portion of the electric device is still inserted into the cylinder 6 when the electric device is displaced relative to the cylinder 6 is applied to a definition that the electric device is mounted inside the cylinder 6. In addition, the rod is not limited to the piston rod 7 that holds the piston; alternatively, the rod may be a rod that is simply accessible into the cylinder.

Although some preferred embodiments of the present invention have been described above in detail, modifications, variations, and changes are still possible without departing from the scope of the claims.

The present application claims priority based on Japanese Patent Application No. 2021-021555 filed with the Japan Patent Office on Feb. 15, 2021, and the entire contents of this application are incorporated into the present specification by reference.

1. A front fork comprising:
a telescopic fork main body having a vehicle body side tube and an axle side tube, the telescopic fork main body being extendable;
a cap placed in a vehicle body side end of the vehicle body side tube;
a cylinder provided inside the axle side tube;
a rod inserted into the cylinder so as to be movable in an axial direction, the rod having one end coupled to the cap;
an electric device mounted inside the cylinder;
an electric wire connected to the electric device;
a suspension spring mounted inside the fork main body, the suspension spring biasing the fork main body in an extending direction; and
an adjuster capable of adjusting a support position of a spring seat by which the suspension spring is supported, wherein
the electric wire is drawn from the cap at a position misaligned from an axial center line of the fork main body to an outside of the fork main body, and
an operational portion of the adjuster is provided in the cap at a position that is misaligned from the axial center line of the fork main body and that is apart from the electric wire.

2. The front fork according to claim 1, wherein
the rod has a tubular shape, and
the electric wire is drawn to an outside of the cylinder through an interior of the rod.

3. The front fork according to claim 1, wherein
the cap includes a lid having a disc shape, a cylindrical portion that protrudes from a fork side end of the lid toward an interior of the fork main body and that has a center aligned with the axial center line, and an electric wire hole leading from an opposite fork main body side end of the lid to the interior of the cylindrical portion, a center of an opening at an opposite fork side end of the lid being misaligned from the axial center line,
the cap is provided with a guide having an annular shape, the guide being mounted inside the electric wire hole, the guide having an inner circumference along which the electric wire is passed, and
the electric wire is inserted into and passed in a bent shape through interiors of the cylindrical portion and the guide.

4. The front fork according to claim 3, further comprising:
an outer circumferential seal ring that seals a gap between an outer circumference of the guide and the cap; and
annular packing that is stacked on the guide and seals a gap between the guide and the electric wire.

5. The front fork according to claim 4, further comprising
an inner circumferential seal ring that seals the inner circumference of the guide and an outer circumference of the electric wire.

6. The front fork according to claim 3, wherein
the guide has a tapered portion on the inner circumference on a fork main body side thereof, the tapered portion having a diameter increasing toward the fork main body side.

7. The front fork according to claim 3, further comprising a stopper on the outer circumference of the electric wire, the stopper facing a fork main body side end of the cylindrical portion.
